(19) United States
(12) Patent Application Publication
(10) Pub. No.: US 2024/0211217 A1
(43) Pub. Date: Jun. 27, 2024

(54) AUTOMATED SCRIPT GENERATION TOOL FOR DATABASE MANAGEMENT

(71) Applicant: AUBTAH LLC, Congers, NY (US)

(72) Inventor: Reza Rasoulinejad, Congers, NY (US)

(73) Assignee: AUBTAH LLC, Congers, NY (US)

(21) Appl. No.: 18/381,468

(22) Filed: Oct. 18, 2023

Related U.S. Application Data
(60) Provisional application No. 63/477,203, filed on Dec. 26, 2022.

(51) Int. Cl. G06F 8/34

(52) U.S. Cl. CPC G06F 8/34

(57) ABSTRACT

Aspects of the present disclosure are directed to a script generation tool for configuring and managing databases and their content in a Relational Database Management System with a single and interactive interface. In one aspect, a method includes receiving an input, via a Graphical User Interface (GUI), the input identifying at least one operation to be performed in a RDBMS and at least one object subject to the operation; generating, in a single iteration, a script for the at least one operation; and outputting the script on the GUI.

This application claims priority to U.S. Provisional Application No. 63/477,203 filed on Dec. 26, 2022, the entire content of which is incorporated herein by reference.

### TECHNICAL FIELD

The subject matter of this disclosure relates in general to the field of computer networking, and more particularly, to configuring, managing, and maintaining databases and content stored therein, in a Relational Database Management System (RDBMS).

### BACKGROUND

One example computer language to communicate and interact with a relational Database Management System (RDBMS) is Structured Query Language (SQL). Different RDBMS vendors, such as Microsoft®, Oracle®, etc., have developed their own customized versions of SQL, including, but not limited to, Transact SQL, PL/SQL, etc.

A typical RDBMS includes various object types such as tables, views, indexes, stored procedures, functions, assemblies, and table level objects such as defaults, checks, indexes, foreign keys. Tables are used to store data which are accessible through the tables or through views or queries executed against the underlying tables. The table data are usually structured as rows and columns when viewed. Indexes can speed up data access. Foreign keys can define relations amongst tables. Checks and defaults may define constraints on data columns. These objects are collectively stored in a container object called database.

A RDBMS can provide a command-line and/or a graphical user interface (GUI) to allow interaction with the databases and the objects present therein. These interfaces provide the ability to perform SQL operations at the database level. SQL operations fall into two main categories: Data Definition Language (DDL) and Data Manipulation Language (DML) although a few categories including, but not limited to, Data Control Language (DCL), exist as well.

### BRIEF SUMMARY

Aspects of the present disclosure are directed to an automated script generation tool for configuring and managing databases and their content in a Relational Database Management System with a single and interactive interface. The scripts (e.g., DDL and DML SQL scripts) may be generated for any action to be performed on objects such as tables, views, synonyms, stored procedures, assemblies, functions and/or any data changes (inserts, updates, deletes, etc.). Such scripts can be generated for any purpose including, but not limited to, migration of databases and objects across different environments such as development, testing and production environments, server-level objects such as logins, backup devices, linked servers, schema changes (adding/altering/dropping) of objects like table columns, table constraints, views, synonyms, stored procedures, assemblies, functions, etc., and/or data changes (e.g., inserts/updates/deletes) performed on tables. In other words, the present disclosure provides means for automatically generating necessary scripts to implement any type of change across relational databases for any operation on the databases.

In one aspect, a method includes receiving an input, via a Graphical User Interface (GUI), the input identifying at least one operation to be performed in a Relational Database Management System (RDBMS) and at least one object subject to the operation; generating, in a single iteration, a script for the at least one operation; and outputting the script on the GUI.

In another aspect, generating the script includes identifying the at least one object in the input; grouping the objects based on a referential order; and generating a corresponding script for each object in the group.

In another aspect, the method further includes adding the corresponding script of each object to generate the script.

In another aspect, the method further includes determining whether the at least one object is missing from the RDBMS; generating an error message indicative of the at least one object missing; and including the error message in the script.

In another aspect, the script is a Structured Query Language (SQL) script.

In another aspect, the at least one operation includes a SQL operation to be performed on at least one database in the RDBMS.

In another aspect, the operation includes migrating at least one database in the RDBMS between two different environments, each of the two different environments being one of a development environment, a test environment, and a deployment environment for the RDBMS.

In one aspect, a device includes one or more memories having computer-readable instructions stored therein and one or more processors. The one or more processors are configured to execute the computer-readable instructions to receive an input, via a Graphical User Interface (GUI), the input identifying at least one operation to be performed in a Relational Database Management System (RDBMS) and at least one object subject to the operation; generate, in a single iteration, a script for the at least one operation; and output the script on the GUI.

In another aspect, the one or more processors are configured to generate the script by identifying the at least one object in the input; grouping the objects based on a referential order; and generating a corresponding script for each object in the group.

In another aspect, the one or more processors are further configured to add the corresponding script of each object to generate the script.

In another aspect, the one or more processors are further configured to determine whether the at least one object is missing from the RDBMS; generate an error message indicative of the at least one object missing; and include the error message in the script.

In another aspect, the script is a Structured Query Language (SQL) script and the at least one operation includes a SQL operation to be performed on at least one database in the RDBMS.

In another aspect, the operation includes migrating at least one database in the RDBMS between two different environments, each of the two different environments being one of a development environment, a test environment, and a deployment environment for the RDBMS.

In one aspect, one or more non-transitory computer-readable media include computer-readable instructions, which when executed by one or more processors of a device, cause the device to receive an input, via a Graphical User Interface (GUI), the input identifying at least one operation to be performed in a Relational Database Management System (RDBMS) and at least one object subject to the operation; generate, in a single iteration, a script for the at least one operation; and output the script on the GUI.

In another aspect, the execution of the computer-readable instructions cause the device to generate the script by identifying the at least one object in the input; grouping the objects based on a referential order; and generating a corresponding script for each object in the group.

In another aspect, the execution of the computer-readable instructions further cause the device to add the corresponding script of each object to generate the script.

In another aspect, the execution of the computer-readable instructions further cause the device to determine whether the at least one object is missing from the RDBMS; generate an error message indicative of the at least one object missing; and include the error message in the script.

In another aspect, the script is a Structured Query Language (SQL) script.

In another aspect, the at least one operation includes a SQL operation to be performed on at least one database in the RDBMS.

In another aspect, the operation includes migrating at least one database in the RDBMS between two different environments, each of the two different environments being one of a development environment, a test environment, and a deployment environment for the RDBMS.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an environment in which aspects of the present disclosure may be implemented according to some aspects of the present disclosure;

FIG. 2 illustrates a non-limiting example of a relational database on which SQL operations may be performed according to some aspects of the present disclosure;

FIGS. 3A-E show snapshots of real-world example of RDMS of FIG. 2 according to some aspects of the present disclosure;

FIG. 4 illustrates a table of example SQL operations that may be performed using the disclosed script generation tool according to some aspects of the present disclosure;

FIGS. 5A-F show non-limiting examples of a GUI of an automated script generation tool according to some aspects of the present disclosure;

FIGS. 6A-F illustrate example operations and output of the disclosed script generation tool according to some aspects of the present disclosure;

FIG. 7 is a flowchart of an example script generation method according to some aspects of the present disclosure;

FIGS. 8A-C illustrate examples of existing tools for SQL scripts.

FIGS. 9A-B show the same column alteration process as described with reference to FIGS. 8A-C, using the disclosed script generation tool according to some aspects of the present disclosure; and

FIG. 10 shows an example of computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein

As noted above, aspects of the present disclosure are directed to an automated script generation tool for configuring and managing databases and their content in a RDBMS. Such tool may be implemented for any RDBMS system that exposes its server and database objects programmatically. Therefore, the concepts described herein are operating system agnostic. For instance, the concepts described herein may be implemented in any platform that supports the Microsoft .NET runtime and applications written targeting the .NET framework.

Computer-readable instructions for implementing functionalities described herein can be stored on any storage media, e.g., Hard Disk, Solid State Device (SSD), Floppy Disk, CDROM, DVD, etc. and can be accessed from a physical, virtual, remote/cloud-based machine (terminal).

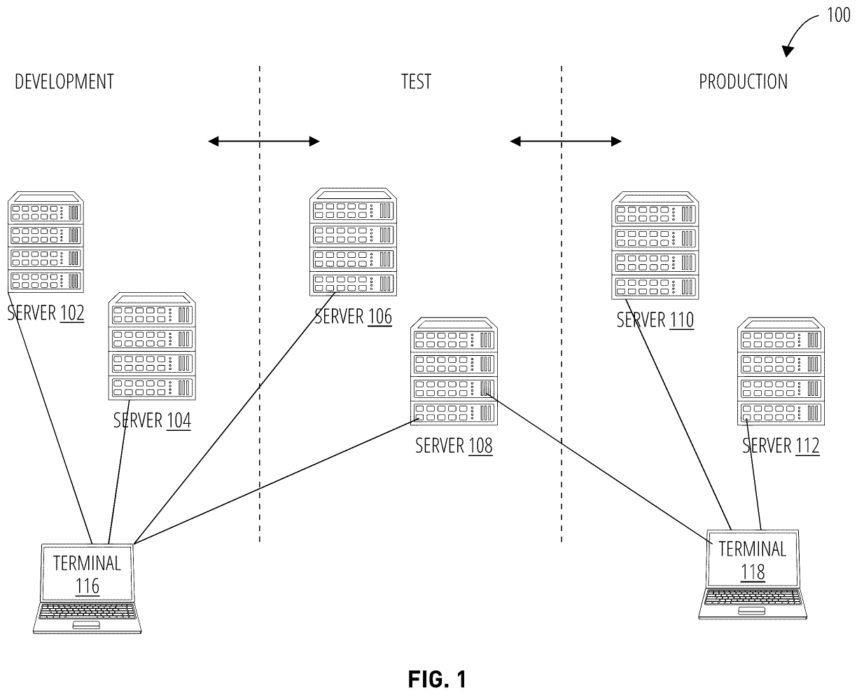

While operating system agnostic, one example and non-limiting environment in which aspects of the present disclosure may be implemented will be described with reference to FIG. 1 below.

FIG. 1 illustrates an environment in which aspects of the present disclosure may be implemented according to some aspects of the present disclosure.

An organization (e.g., a corporation) may regularly, or from time to time, develop and deploy various software tools related to their underlying business. Furthermore, an organization may have any number of different databases for storing data. For example, a database may be used for keeping customer data, another database may be used for keeping human resource related data, employee information, their salaries, and contact information, etc. Another database may be used to keep track of customer orders, product manufacturing, and/or any other purpose for which an organization may store data of interest. Software development and/or

Example environment 100 may be utilized by a single organization (a private set of servers, which may be cloud-based or local) or multiple organizations (a public or private-public cloud-based service to which organizations may subscribe and use). Example environment 100 conceptually illustrates a number of servers that may be utilized by an organizations.

These servers may be broken down into servers used for development of a particular software application or database, servers used for testing a developed application or database (prior to deployment for actual use), and servers used for deployment of a developed application or database. In this non-limiting example, server 102 and server 104 are shown as being used in the development stage, server 106 and server 108 are shown as being used in the test stage, and server 110 and server 112 are shown as being used in the deployment stage. However, the present disclosure is not limited thereto and any number of servers shown in environment 100 may be used in and across any one or more of the stages shown. Furthermore, the number of servers in environment 100 is not limited to just servers 102-112 and may be more or less.

Furthermore, environment 100 may include any number of terminals such as Terminal 116 and terminal 118. While FIG. 1 shows that a number of servers 102-112 may be connected to terminal 116 or terminal 118, the present disclosure is not limited thereto and each of terminal 116 and terminal 118 may be connected to any and/or all of servers 102-112. Also, the number of terminals in environment 100 is not limited to terminal 116 and terminal 118 and may be more or less.

Each of terminal 116 and 118 may be a mobile device, a laptop, a desktop, a tablet, and/or any other type of known or to be developed computer device capable of communicating with servers 102-112.

Communication among servers 102-112 and/or terminals 116 and 118 may be based on any type of known or to be developed wired and/or wireless communication protocols.

As noted above, RDBMS can provide a command-line and/or a graphical user interface (GUI) to allow interaction with the databases and the objects present therein. These interfaces provide the ability to perform SQL operations at the database level. SQL operations fall into two main categories: Data Definition Language (DDL) and Data Manipulation Language (DML) although a few categories including, but not limited to, Data Control Language (DCL), exist as well. Using the GUI, a network operator (database operator) can create, modify, and drop objects, and perform insert, update, and delete operations. However, generating the scripts that capture the actions taken using the same GUI quite often is a manual process prone to almost-guaranteed errors, which are often extremely time consuming to identify and remedy. In some instances, generating the scripts are not even supported. Hence, there is a need to have the ability to automatically generate the scripts for the actions taken by a user using the GUI provided by the RDBMS and/or in general scripts for any subset of the database or the database server objects.

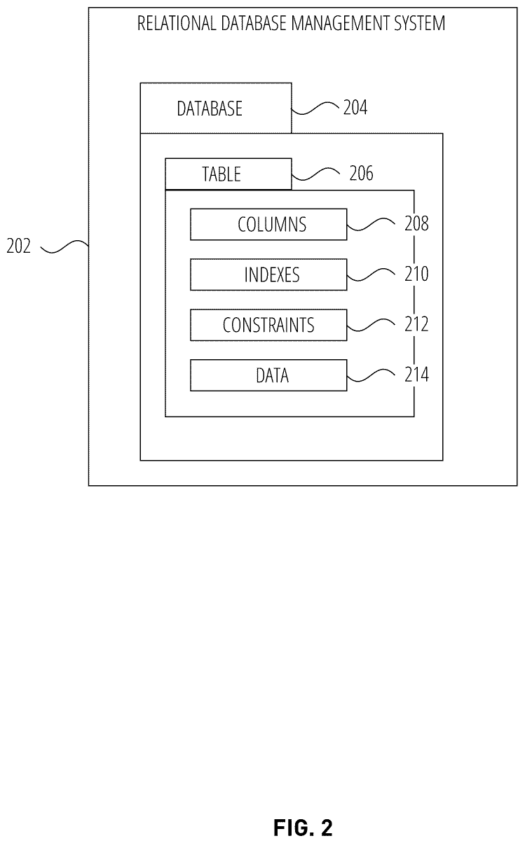

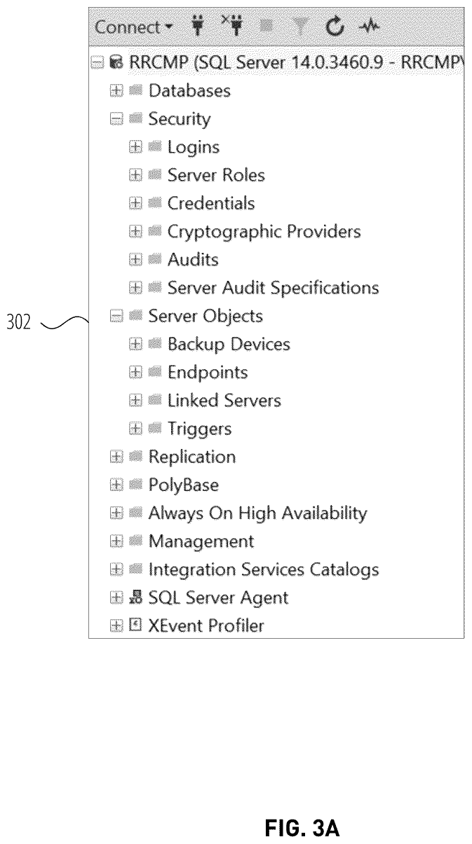

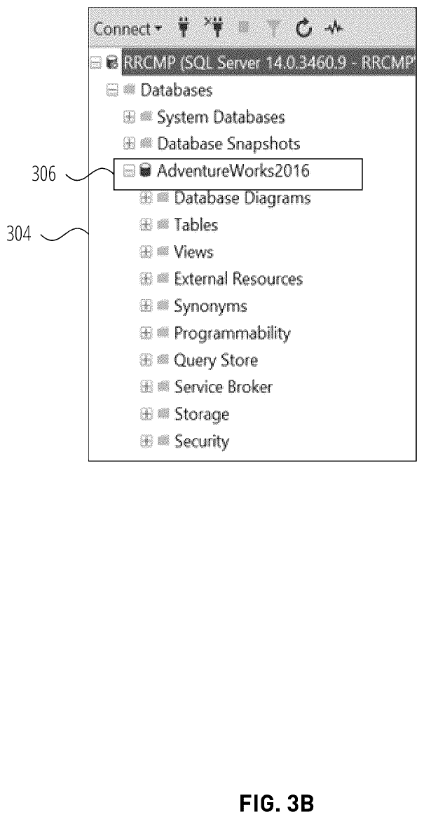

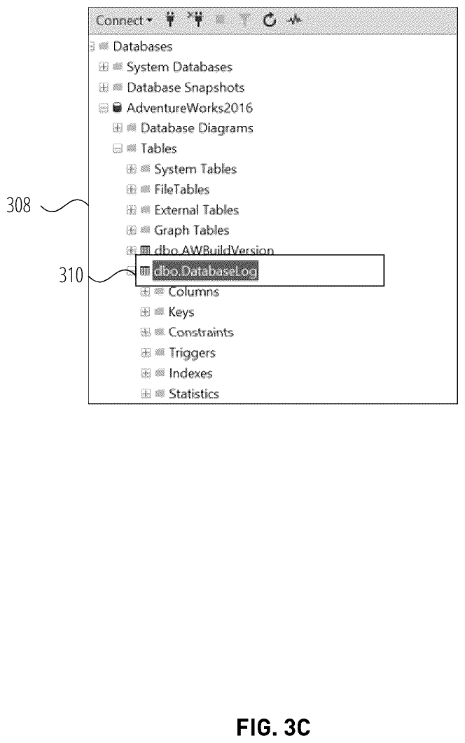

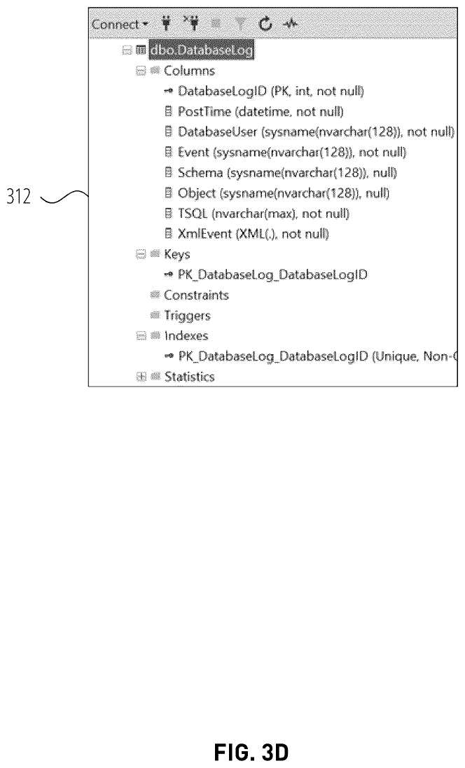

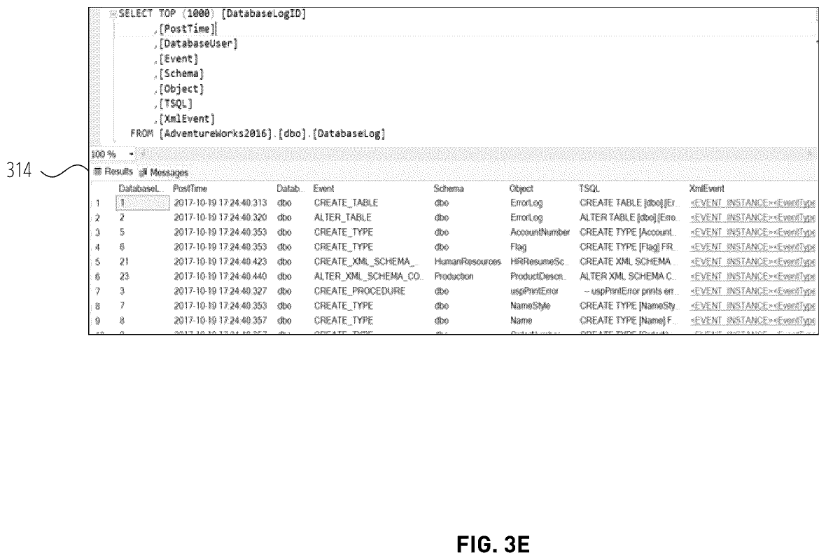

FIG. 2 illustrates a non-limiting example of a relational database on which SQL operations may be performed according to some aspects of the present disclosure. Example RDMS 202 can include one or more database such as database 204, with one example table 206 shown therein. Table 206 can include columns 208, indexes 210, constraints 212, and data 214. Table 206 can also include relationships (e.g., foreign keys), as well as other information. In addition to table 206, database 204 can include objects such as views, users, stored procedures, etc. Several real-world snapshots of an example RDMS 202 will be shown below with reference to FIGS. 3A-E.

FIGS. 3A-E show snapshots of a real-world example of RDMS of FIG. 2 according to some aspects of the present disclosure. FIG. 3A shows snapshot 302 of example RDMS 302 that includes several objects such as Databases, Security, Replication, etc., as shown. This example RDMS 302 is a non-limiting implementation of Microsoft SQL Server (MSSQL Server).

FIG. 3B shows snapshot 304 of a database in RDMS 302, in which a particular database named Adventure Works2016 306 is shown with an expanded view. Adventure Works2016 306 is an example of database 204 of FIG. 2.

FIG. 3C shows snapshot 308 of a table 310 (dbo.DatabaseLog) that is part of database 204 (under AdventureWorks2016) in RDMS 302. As can be seen, table 310 can include columns, indexes, constraints, keys, triggers, statistics, etc.

FIG. 3D shows snapshot 312 of example contents under the columns of table 310 including DatabaseLogID, PostTime, DatabaseUser, etc., as well as an example content under keys, as shown.

FIG. 3E shows snapshot 314 of table 310 and content stored therein. For instance, DatabaseLogID of table 310 can include a number of columns such as PostTime, DatabaseUser, Event, Schema, Object, TSQL, xmlEvent, etc., each having a corresponding value stored therein.

Users of database systems such as those described above with reference to non-limiting example database of FIGS. 3A-E, regularly need to generate scripts (e.g., SQL scripts) for the objects and data they create, alter, drop, delete, either for the entire database or a selected subset of database objects or data. Quite often, the main tool available to database developers and users for generating scripts is the one that comes with a specific RDBMS, and such tools lack the automation and level of granularity that the present disclosure provides through an easy-to-use graphical user interface. For instance, for a given database build or deployment, a user may only desire to push a set of tested changes to all or a subset of stored procedures, all or a subset of tables with data for some of them, and/or alter statements for certain modified functions. Existing tools (e.g., RDBMS specific tools) do not provide the functionality to generate SQL scripts for just the desired change/operation and often generate a script for the entire database, which is inefficient, resource and time intensive, and inconvenient.

Aspects of the present disclosure, as will be described in more detail below, provides the ability to pick and choose database-level or database server-level objects (e.g., logins, backup devices, linked servers, message queues, etc.) by type and name or wildcard name patterns, for any or all subsets of objects and data, and then automatically generates the scripts for them without generating an overall SQL script for the entire database. For instance, the graphical user interface and the underlying functionalities performed thereby, can, in a single iteration, script out (e.g., generate SQL script) for (1) all of a database's stored procedures and functions by any combination of schema and name, (2) all of the indexes or default constraints for a subset of the tables, and/or (3) changed data stored in just a subset of the tables in a given database such as tables, columns, views, stored procedures, constraints, indexes, and data. Furthermore, aspects of the present disclosure allow for use of wildcards in any of the scenarios (1)-(3) above.

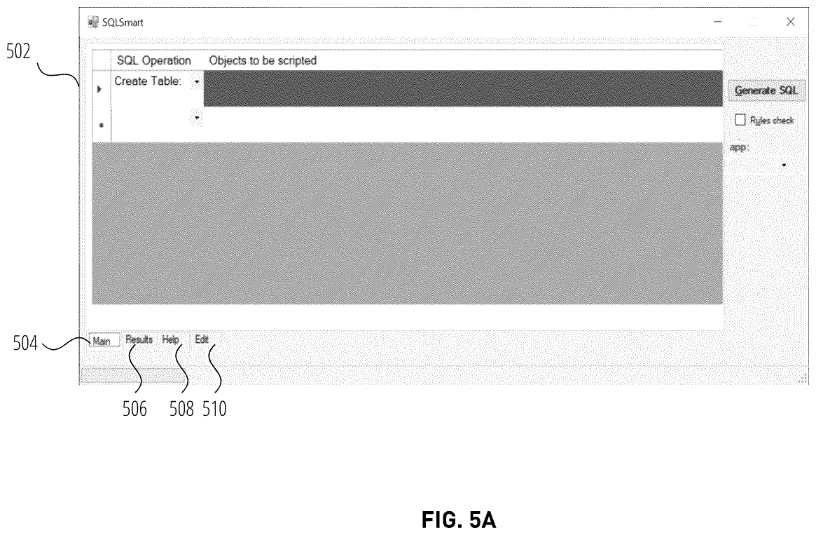

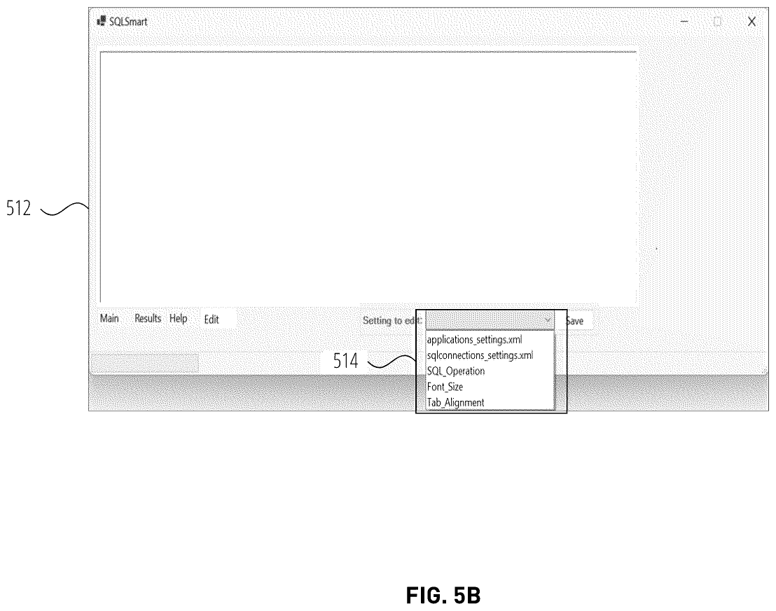

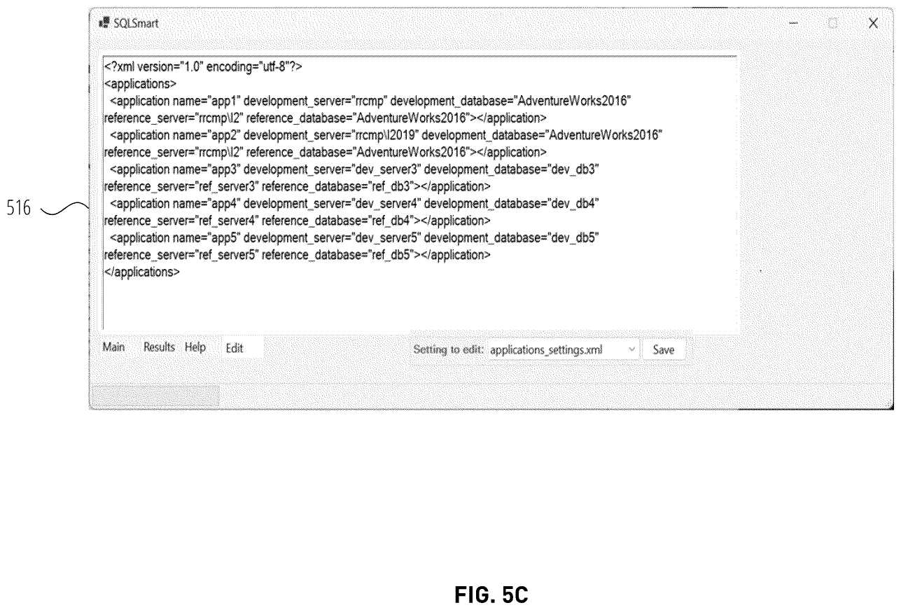

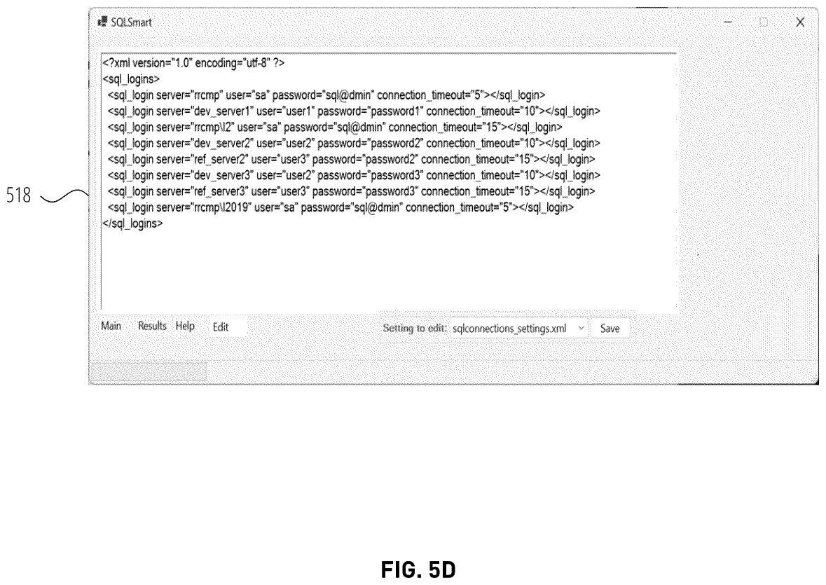

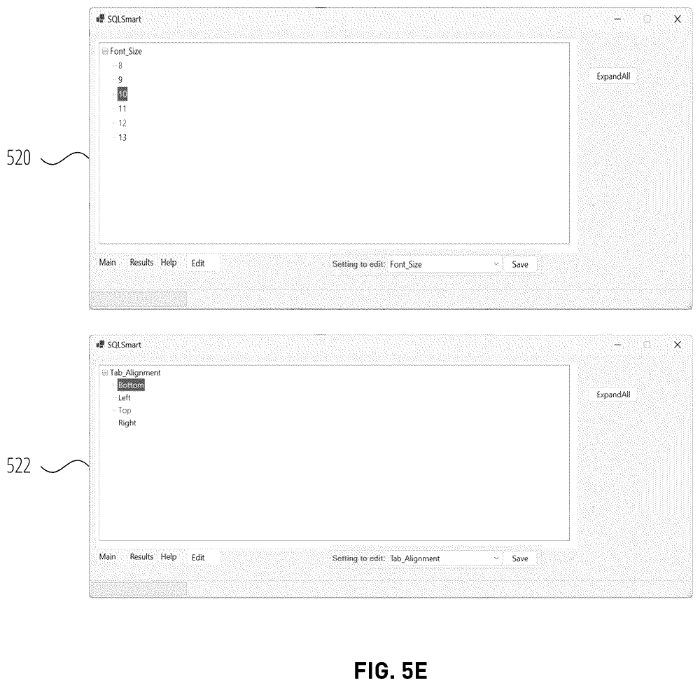

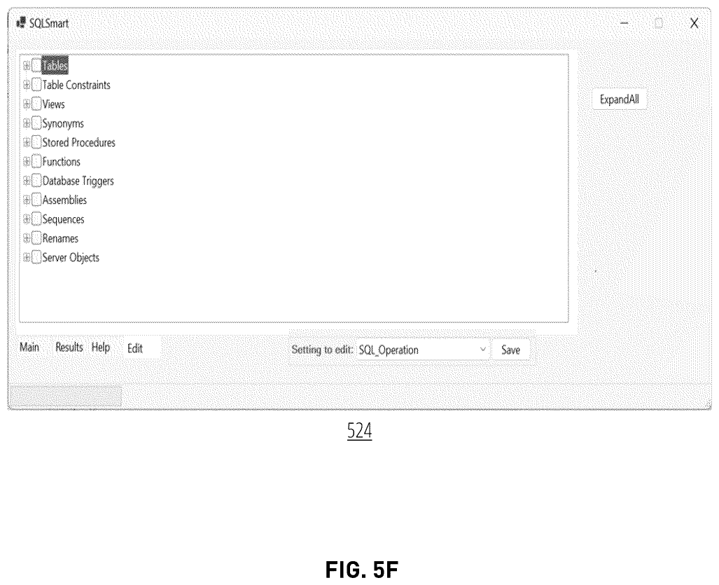

As will be shown below with reference to FIGS. 5A-F, the present disclosure provides an interactive GUI that can generate scripts for any subset of database objects in an easy and quick fashion (single iteration). Doing so, compared to existing script generators and methodologies, can provide significant time and value savings.

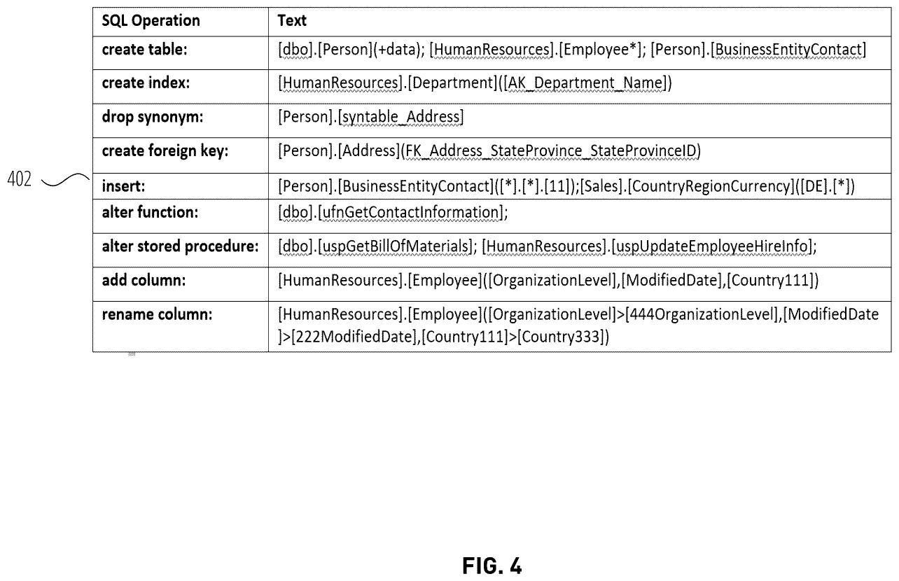

FIG. 4 illustrates a table of example SQL operations that may be performed using the disclosed script generation tool according to some aspects of the present disclosure. Table 402 shows non-limiting examples of different types of SQL operations that may be performed on any given number of databases and/or related objections such as those described above with reference to FIGS. 1 through 3A-E. Using a GUI of the present disclosure as will be described below, a database operator may simply enter a desired SQL operation (e.g., “create table”) and then list the desired objects “[dbo].[Person](+data); [HumanResources].[Employee*]; [Person].[BusinessEntityContact]”, as shown in table 402. The same process may be repeated for other SQL commands, including but not limited to those shown in table 402 (e.g., “create index”, etc.) In some examples, wildcards can also be used to specify an array of object names.

With a desired operation (e.g., an SQL operation) specified as an input into a GUI of the present disclosure, the GUI will provide the corresponding script as an output. This will be described below with reference to FIGS. 5A-F. While FIGS. 5A-F are used to show examples of how to use a GUI for generating a script for any operation on a database, the present disclosure is not limited thereto. For instance, or in addition to a GUI, a command line interface and/or a Dynamic Data Library (DLL) may be used.

FIGS. 5A-F show non-limiting examples of a GUI of an automated script generation tool according to some aspects of the present disclosure. It should be noted that while some examples of a GUI according to the present disclosure are being described below with reference to FIGS. 5A-F, the present disclosure is not limited thereto and the appearance and/or design of GUI may change according to any desired and/or to be developed criteria.

FIG. 5A shows example screenshot 502 of a GUI via which a desired input for an operation (e.g., SQL operation) on a given database and/or any components thereof may be specified. For instance, screenshot 502 shows example input of “create table”, which may be specified via the main tab 504. As shown, this example GUI also has tabs 506, 508, and 510. Tab 506, when selected, can provide the script generated for the desired input. Tab 508, when selected, can provide a user with answers to questions (help). Tab 510 allows the user to make edits to the appearance of the GUI (e.g., font, tab alignment, etc.). Further operations available under tab 510 will be described with reference to FIG. 5B.

FIG. 5B shows example screenshot 512 when tab 510 (edit) is selected. In this section, changes can be made to configuration files (e.g., “applications_settings.xml”), to the interface (e.g., changing the “Font Size”, or the “Tab Alignment”), and/or adding and removing “SQL Operations”. These changes can be made via the dropdown menu 514 shown in FIG. 5B.

Screenshot 516 of FIG. 5C shows an example interface where “application_settings.xml” is selected via dropdown menu 514 of FIG. 5B. This option may be selected to modify/add/delete new application entries, which once entered can be saved using the “save” tab shown in screenshot 516.

Screenshot 518 of FIG. 5D shows an example interface where “sqlconnections_settings.xml” is selected via dropdown menu 514 of FIG. 5B. This option can be selected to modify/add/delete settings associated with any SQL application, which once entered can be saved using the “save” tab shown in screenshot 518.

Screenshot 520 of FIG. 5E shows an example interface where “Font_size” is selected via dropdown menu 514 of FIG. 5B. This option can be selected to change size, color, font type, and/or any other parameter associated with displaying the GUI. Similarly, screenshot 522 shows an example where alignment of texts and/or location of tabs on the GUI may be specified. Once the desired changes are made, they can be saved using the “save” tab shown in screenshot 520 and 522.

Screenshot 524 of FIG. 5F shows an example interface that can be used to add or remove SQL operations such as those described above with reference to FIG. 4. In one example, SQL operations may be defined for specific objections (e.g., for Tables, Views, Synonyms, etc.).

With various settings of example GUI of the present disclosure being specified and saved via interfaces described with reference to FIGS. 5A-F, the present disclosure next turns to describing example inputs and generated script outputs.

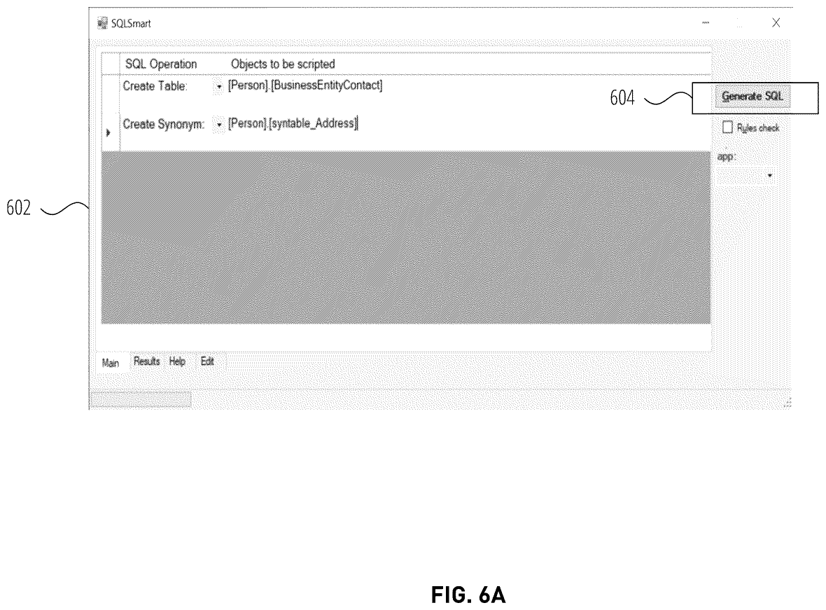

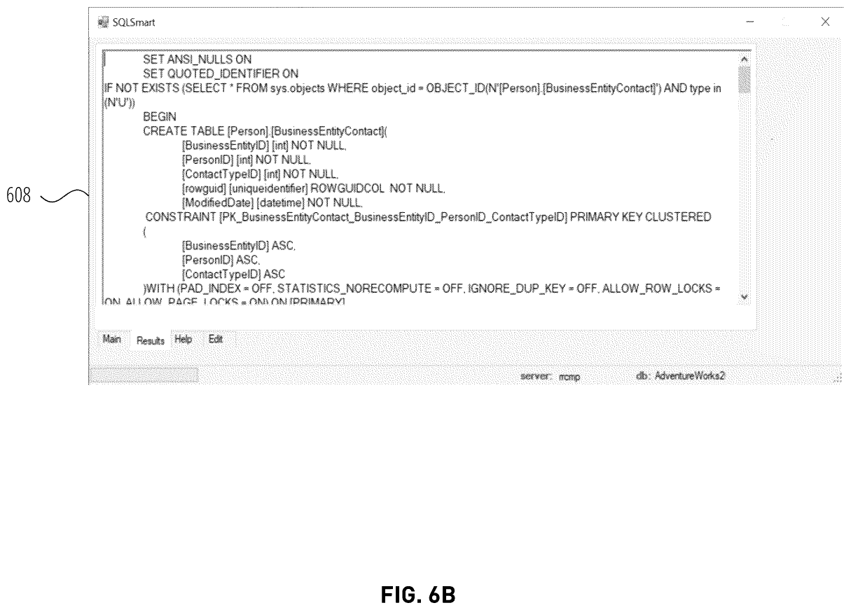

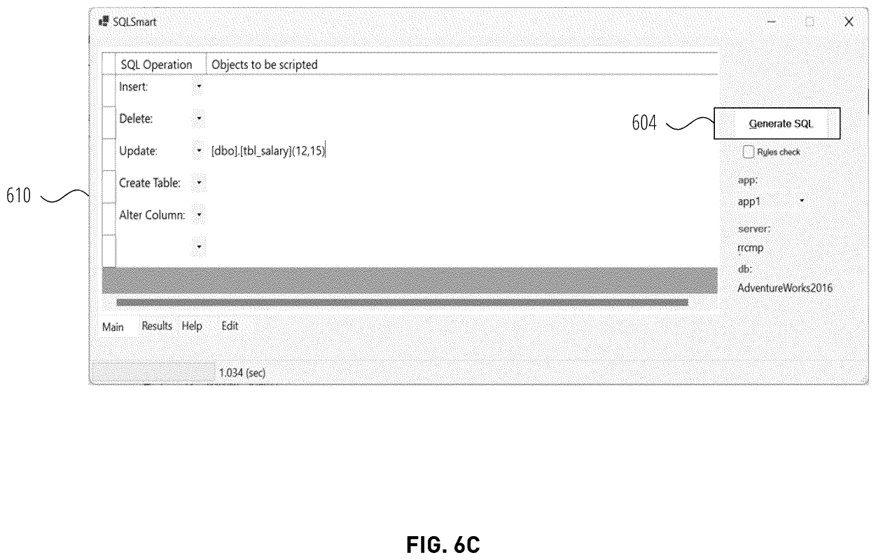

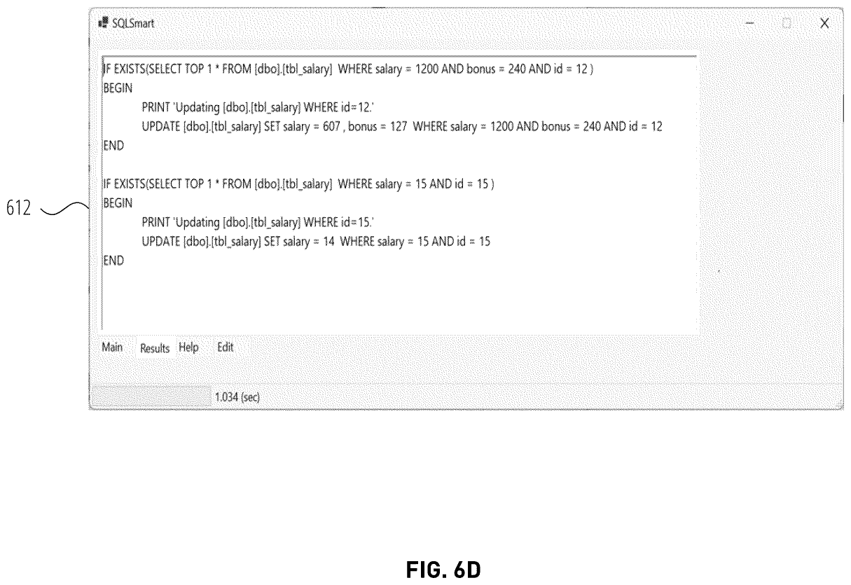

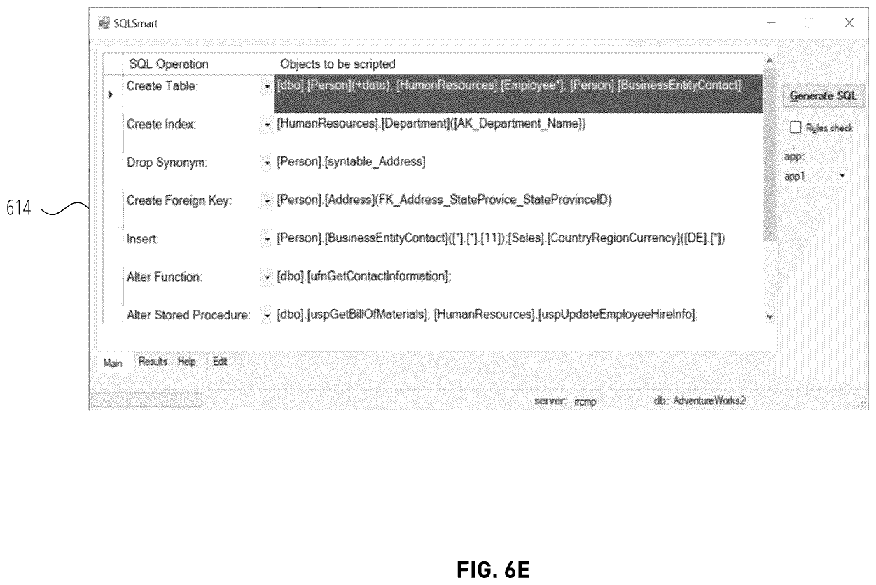

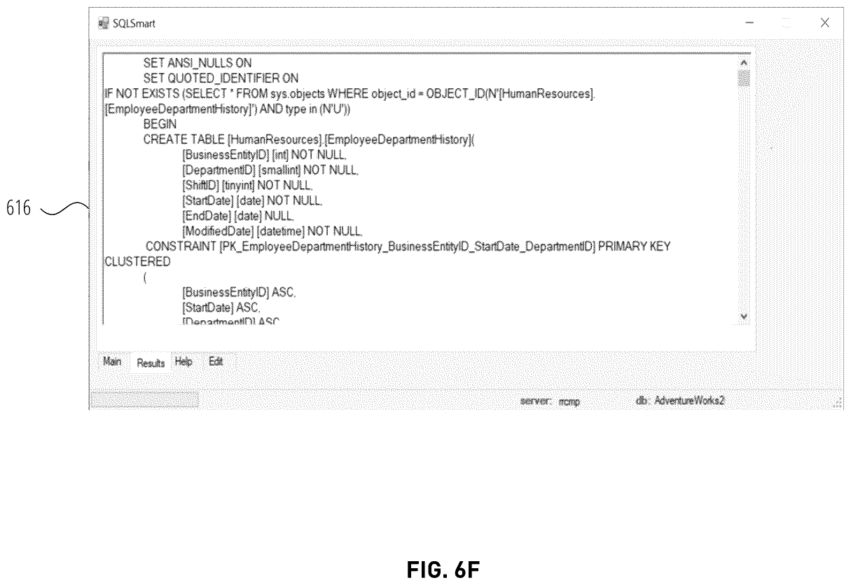

FIGS. 6A-F illustrate example operations and output of the disclosed script generation tool according to some aspects of the present disclosure. FIG. 6A shows example interface 602 via which SQL operations such as “Create Table” and “Create Synonym” as well as their respective values (under “Objects to be scripted”) may be specified. Once specified, tab 604 (“Generate SQL”) may be selected. Selecting tab 604 generates the desired SQL script, an example of which is shown in screenshot 608 of FIG. 6B.

FIG. 6C shows another example interface 610 via which capturing updates of individual records may be implemented. As noted above, one of the advantageous aspects of the present disclosure is the ability of implementing targeted and individual changes to any portion of part of a database and generating relevant scripts therefore, without the need for generating a database-wide scripts as is done currently using available tools.

For instance, screenshot 610 illustrates that SQL operation “Update” may be specified for a particular table and more specifically particular columns thereof (e.g., column values 12 through 15 of [dbo].[tabl_salary]). Alternatively, a range of column values may be specified (e.g., [dbo].[tbl_salary](12-15)). In another example, a wildcard range of column values may be specified (e.g., [dbo].[tbl_salary]([1].[*]).

As sample generated script of screenshot 612 in FIG. 6D illustrates, changes to specified column values (e.g., 12 through 15, per the SQL operation input of FIG. 6C) may be identified by pinpointing exactly where the changes have happened. In one example, if there are no changes, the output in FIG. 6D may simply indicate: “Update:[dbo].[tbl_salary](id=16): No changes have been detected.”

Similar operations and associated scripts may be obtained for other examples mentioned above (e.g., range of columns, a wildcard range, etc.).

In some aspects, a script may be generated for multiple operations (e.g., several different SQL operations) in a single iteration. FIG. 6E is a snapshot 614 of a GUI through which multiple different SQL operations may be specified along with relevant objects and their values.

FIG. 6F illustrates an example output 616 of a script for the multiple operations specified via the GUI as shown in FIG. 6A.

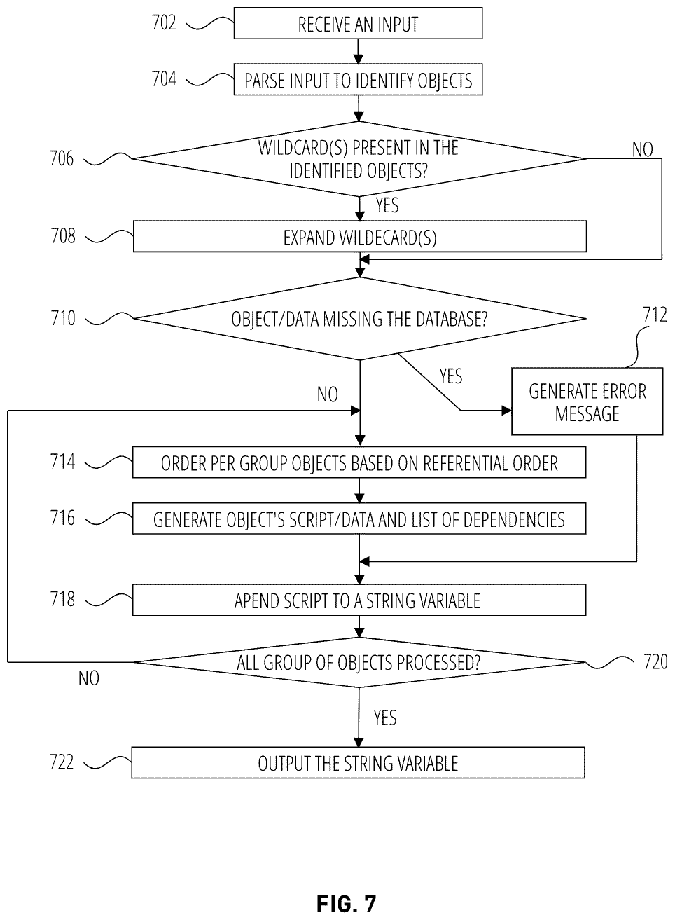

FIG. 7 is a flowchart of an example script generation method according to some aspects of the present disclosure. FIG. 7 and steps involved will be described from the perspective of terminal 116 of FIG. 1. However, it should be understood that Terminal 116 may have one or more memories associated therewith with computer-readable instructions stored therein, which when executed by one or more processors, can cause terminal 116 to perform steps (described below as individual blocks) of FIG. 7 as described below. Furthermore, while terminal 116 is used as an example computer device that can be configured to install and execute computer-programs to provide automated script generation capabilities described herein, the present disclosure is not limited thereto. For instance, terminal 118 can be used to implement the steps of FIG. 7. Furthermore, any other computer device capable of establishing network connectivity to one or more databases such as databases 102-112 of FIG. 1 and configured to execute computer-readable instructions can be used to implement the aspects of the present disclosure including steps of FIG. 7 described hereinafter.

At block 702, terminal 116, may receive an input. As described above, this input can be received via a GUI (e.g., as shown in example screenshot 502 of FIG. 5A, screenshot 602 of FIG. 6A, screenshot 610 of FIG. 6C, etc.). The input, as described above, can be any action to be performed on a given database and/or objections and components thereof including, but not limited to, SQL operations, database migration from one environment to another, etc.

In one example, the input may include a specified action (e.g., a particular SQL operation), one or more objects and/or data to be scripted (e.g., databases, indexes, constraints, keys, etc.), and one or more values associated with those objects (e.g., specific or range of columns as described with reference to non-limiting example of FIGS. 6C-D.

At block 704, terminal 116 may parse the input received at block 702 to identify objects and/or data that are subject to the requested action identified in the input. This parsing can be performed according to any known or to be developed process for parsing the language of the input.

At block 706, terminal 116 determines whether one or more wildcards are present in the identified objects or not. An example of a wildcard has been described above with reference to FIG. 6C.

If wildcards are not present, the process skips to block 710, which will be described below. However, if terminal 116 determines that one or more wildcards are present, then at block 708, terminal 116 expands the one or more wildcards.

Thereafter, at block 710, terminal 116 determines whether any object or data identified in the input are missing from the relevant table or database. If an identified object or data is missing, at block 712, terminal 116 generates an error message that may be displayed on a GUI such as the example GUI of FIG. 5A (e.g., under results tab 506). Thereafter, the process may proceed to block 718 which will be described below.

If at block 710, terminal 116 determines that no identified object or data is missing, then at block 714, terminal 116 orders the objects (per group) based on referential order. Non-limiting examples of this ordering will be described next.

Databases are generally designed based on normalization rules, which allow relationships amongst objects to be established and to be discoverable, and further, given the inherent nature of databases, relationships and dependencies amongst database objects also become discoverable.

Normalization is the process of structuring a relational database in accordance with a series of so-called normal forms in order to reduce data redundancy and improve data integrity. Normalization can be implemented in RDBMSs as a relationship (may be referred to as Foreign Key mentioned above). For instance, given a table named “Employee” which holds information for the company employees, one can create a table named “EmployeePayHistory” to hold the details of the payments made to the employees whose information is stored in the “Employee” table. However, to ensure integrity of the data in the “EmployeePayHistory” table and ensure that only the information on Employees whose names appear in the “Employee” table appear in the “EmployeePayHistory” table, a relationship (foreign key) has to be created between the “EmployeePayHistory” and “Employee” Tables. This can be achieved by creating the column named “BusinessEntityID” in the “EmployeePayHistory” and linking it to its counterpart column “BusinessEntityID” in the “Employee” table through a foreign key. This will ensure that only BusinessEntityID values that exist in the BusinessEntityID column of the “Employee” table can be stored on the “EmployeePayHistory”; simply said, the “EmployeePayHistory” table will only have data for employees whose information is stored in the “Employee” table.

Dependencies can describe the hierarchy of database objects. For example, a stored procedure named “SP1” can invoke a second stored procedure called “SP2” and a function named “FN2”. In this instance, SP1 becomes dependent on “SP2” and “FN2”; if “SP1” is executed and “SP2” does not exist, the execution of “SP1” will fail. The same holds true when “FN2” does not exist or is inaccessible.

Any DDL or DML operation has to honor the relationships and dependencies that exist within a database. Otherwise, the integrity of the underlying data may be compromised. Using the example shown above, any DMLs (e.g., INSERT, UPDATE, DELETE) on the “EmployeePayHistory” table can succeed if the values affected in the foreign key column(s) exist in the parent table(s) (e.g., an arbitrary value in the “BusinessEntityID” column in the “EmployeePayHistory” table that does not exist in the “Employee” table, cannot be saved).

Furthermore, non-deletion modification DDLs on the “BusinessEntityID” column of the “EmployeePayHistory” table has to be performed on the parent column first (e.g., “BusinessEntityID” in “Employee” table). Any deletion DDLs that affect the “BusinessEntityID” column of the “Employee” table have to be performed on the child column first, (e.g., “BusinessEntityID” in “EmployeePayHistory” table).

Therefore, any schema or data changes on objects within a database will have to be performed in the order that honors the (foreign key) relation(s) that exist amongst the objects to be modified.

After completing the ordering of objects, at block 716, terminal 116 may generate a script/data for each ordered object as well as a list of dependencies for that (those) object(s).

At block 718, terminal 116 appends (adds to) an overall script to be outputted with the script/data generated at block 716. If an error message is received from block 712, the error message may be appended to the overall script as well.

At block 720, terminal 116 determines if all groups of objects are processed. If not, the process reverts back to block 714 and blocks 714-720 are repeated until all groups of objects have been processed.

Once, at block 720, terminal 116 determines that all groups of objects are processed, the process proceeds to block 722, where Terminal 116 outputs the overall script via a GUI such as snapshots 608 and 612 of FIG. 6B and FIG. 6D, respectively.

By implementing the steps of FIG. 7 as described above, in a single iteration and for any desired level of granularity, a scrip may be generated by any desired operation on a database. This significantly improves the efficiency and speed with which such tasks may be performed compared to currently available tools.

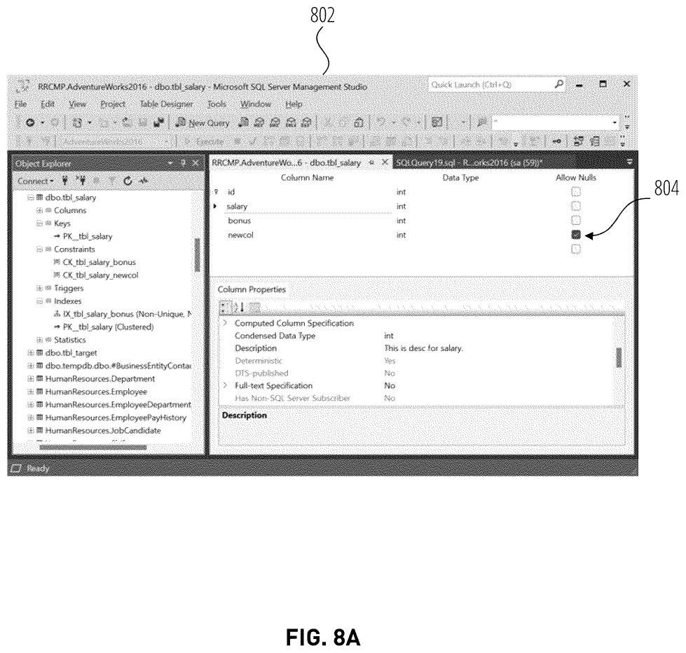

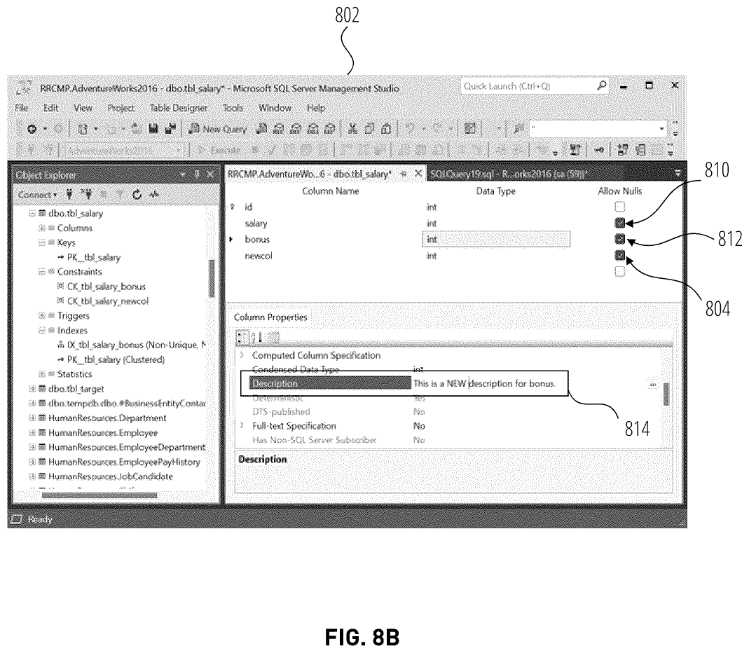

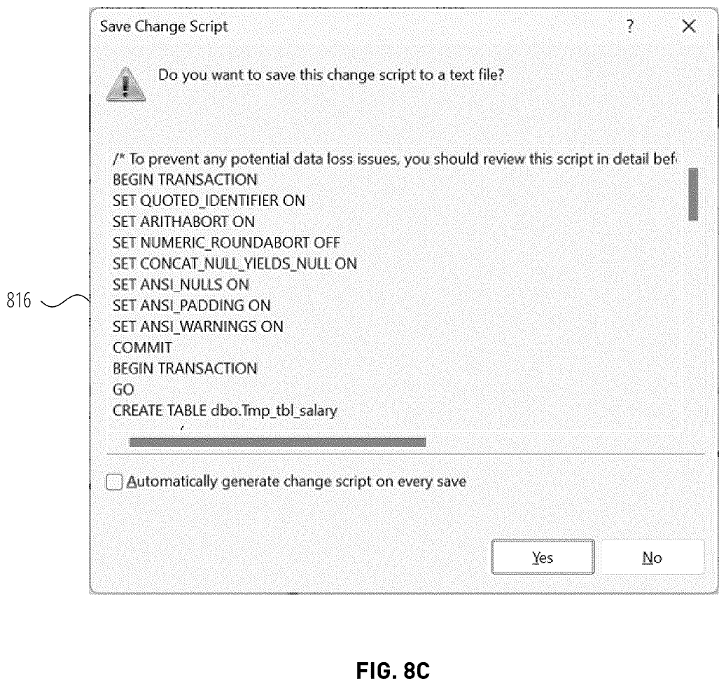

To illustrate this technological improvement over existing database scripting tools available in the market, a tool called Microsoft SQL Server Management Studio (SSMS) that is currently available with Microsoft SQL server for configuring, managing, and administering databases will be described with reference to FIGS. 8A-C.

FIGS. 8A-C illustrate examples of existing tools for SQL scripts. FIG. 8A illustrates an example of SSMS 802 showing a table [dbo].[tbl_salary]. The example process to be performed on this salary table is to modify salaries and bonuses. First, Nulls must be allowed. Hence, “Allow Nulls” is selected as shown in portion 804.

As shown in FIG. 8B, in SSMS 802, both [salary] and [bonus] should be selected to allow Nulls (see 810 and 812 in FIG. 8B). Furthermore, description of both salary and bonus would have to be changed to indicate “This is a NEW description for salary” or “This is a NEW description for bonus” (e.g., see 814 in FIG. 8B).

Once the ‘Generate Change Script’ command is selected in SSMS 802, a pop-up screen such as example snapshot 816 of FIG. 8C may be provided on a display (partial view provided in FIG. 8C).

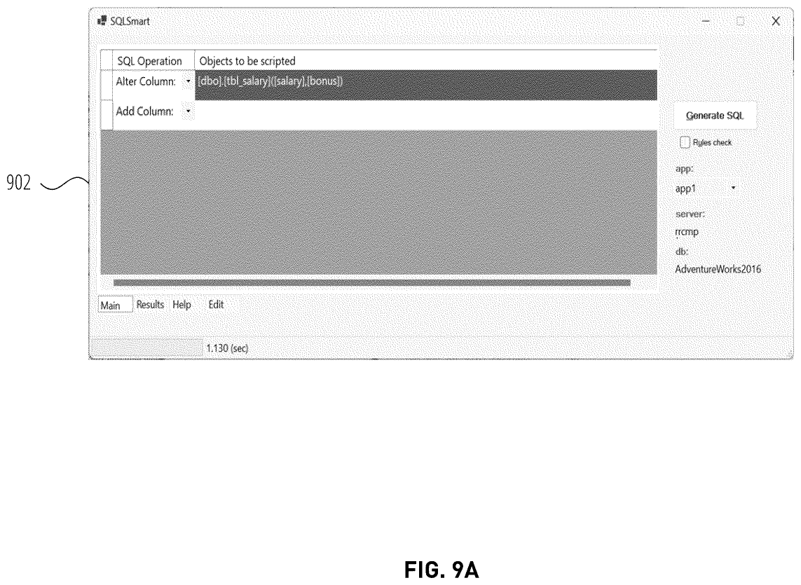

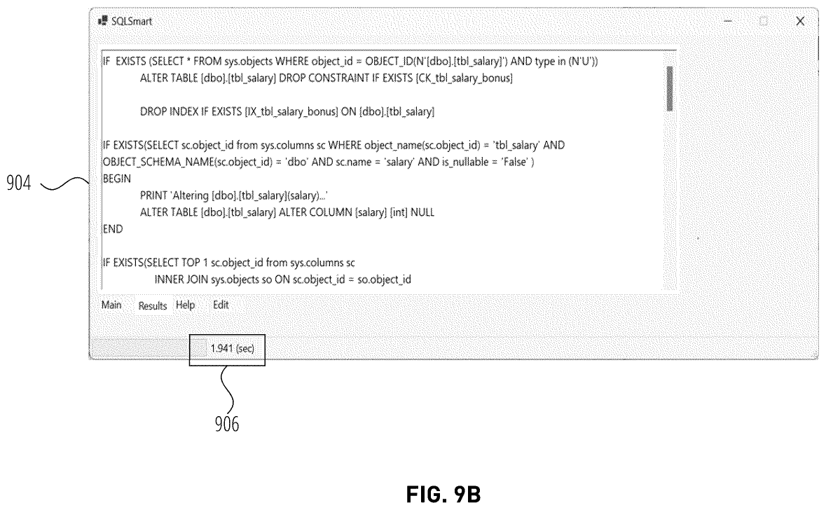

FIGS. 9A-B show the same column alteration process as described with reference to FIGS. 8A-C, using the disclosed script generation tool according to some aspects of the present disclosure.

Compared the SSMS process described above, FIG. 9A shows a snapshot 902 of a simple input that can be provided for altering salary and bonus objects in a table using GUI of the present disclosure. Once ‘Generate SQL’ is selected, example snapshot 904 of FIG. 9B may be generated, which is the desired script. It should be noted that the time it took to generate the script using the script generation tool of the present disclosure is only 1.941 seconds (see 906 in FIG. 9B).

The difference between what the script generation tool of the present disclosure generates and that generated by SSMS described with reference to FIGS. 8A-C, are the following:

The script generation tool of the present disclosure performs the entire operation in three main steps and DOES NOT drop the table nor does any data manipulation. In doing so, (1) only the dependent objects (index, check, default, etc.) on the columns are dropped and not the entire table, (2) modifications are then made to the columns, and (3) objects dropped in (1) are re-created.

SSMS performs a number of unnecessary steps including (1) creating a temporary table and placing a lock on it, (2) updating the column descriptions, (3) copying the entire data in the affected table into the temporary table, (4) dropping the existing table, (5) renaming the temporary table to the existing table, and (6) recreating the constraints.

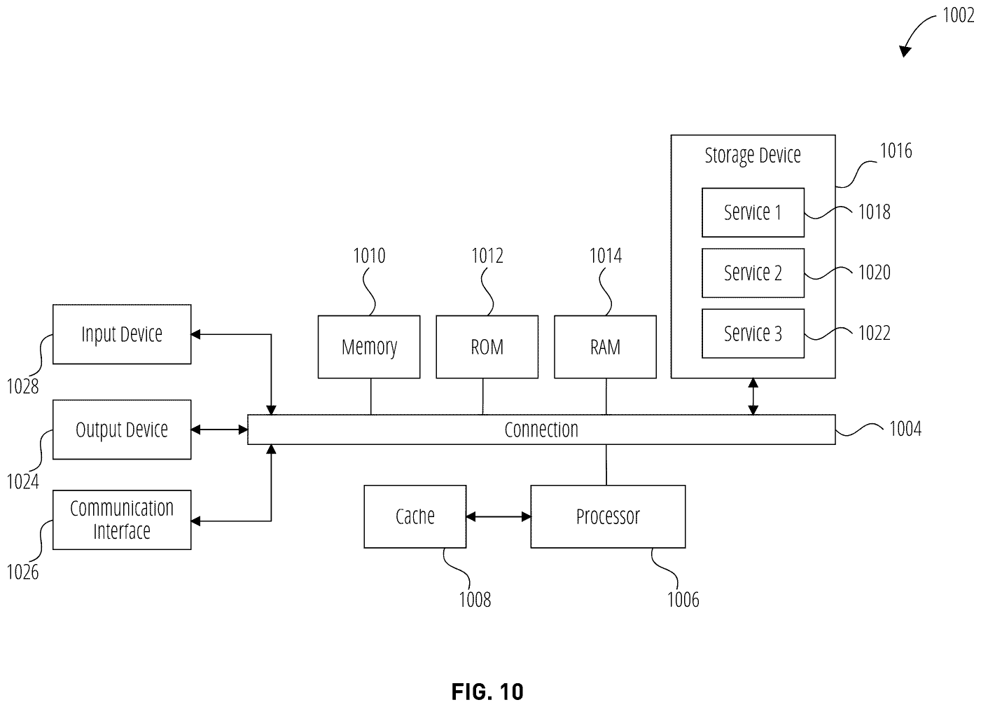

FIG. 10 shows an example of computing system, according to some aspects of the present disclosure. Example computing device 1002 can be used as Terminal 116, terminal 118, and/or any other network component in example environment 100 of FIG. 1. Components of example computing system 1002 may be in communication with each other using connection 1004. Connection 1004 can be a physical connection via a bus, or a direct connection into processor 1006, such as in a chipset architecture. Connection 1004 can also be a virtual connection, networked connection, or logical connection.

In some embodiments, computing system 1002 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1002 includes at least one processing unit (CPU or processor) 1006 and connection 1004 that couples various system components including system memory 1010, read-only memory ROM 1012, and random access memory (RAM) 1014 to processor 1006. Computing system 1002 can include a cache of high-speed memory 1008 connected directly with, in close proximity to, or integrated as part of processor 1006.

Processor 1006 can include any general purpose processor and a hardware service or software service, such as services 1018, 1020, and 1022 stored in storage device 1016, configured to control processor 1006 as well as a special-purpose processor where software instructions are incorporated into the actual processor design. Processor 1006 may essentially be a completely self-contained computing system, containing multiple cores or processors, a bus, memory controller, cache, etc. A multi-core processor may be symmetric or asymmetric.

To enable user interaction, computing system 1002 includes an input device 1028, which can represent any number of input mechanisms, such as a microphone for speech, a touch-sensitive screen for gesture or graphical input, keyboard, mouse, motion input, speech, etc. Computing system 1002 can also include output device 1024, which can be one or more of a number of output mechanisms known to those of skill in the art. In some instances, multimodal systems can enable a user to provide multiple types of input/output to communicate with computing system 1002. Computing system 1002 can include communication interface 1026, which can generally govern and manage the user input and system output. There is no restriction on operating on any particular hardware arrangement, and therefore the basic features here may easily be substituted for improved hardware or firmware arrangements as they are developed.

Storage device 1016 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1016 can include software services, servers, services, etc., that when the code that defines such software is executed by the processor 1006, it causes the system to perform a function. In some embodiments, a hardware service that performs a particular function can include the software component stored in a computer-readable medium in connection with the necessary hardware components, such as processor 1006, connection 1004, output device 1024, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

1. A method comprising:
receiving an input, via a Graphical User Interface (GUI), the input identifying at least one operation to be performed in a Relational Database Management System (RDBMS) and at least one object subject to the operation, at a database layer;
identifying the at least one object in the input;
automatically generating, in a single iteration, a Structured Query Language (SQL) script for the at least one operation using a grouping of the at least one object identified in the input, wherein the script is used to build a new software database based thereon; and
outputting the script on the GUI.

2. The method of claim 1, wherein automatically generating the script comprises:
grouping the at least one object based on a referential order; and
generating a corresponding script for each object in the group.

3. The method of claim 2, further comprising:
adding the corresponding script of each object in the group to generate the script.

4. The method of claim 1, further comprising:
determining whether the at least one object is missing from the RDBMS;
generating an error message indicative of the at least one object missing; and
including the error message in the script.

5. (canceled)

6. The method of claim 1, wherein the at least one operation includes a SQL operation to be performed on at least one database in the RDBMS.

7. The method of claim 1, wherein the operation includes migrating at least one database in the RDBMS between two different environments, each of the two different environments being one of a development environment, a test environment, and a deployment environment for the RDBMS.

8. A device comprising:
one or more memories having computer-readable instructions stored therein; and
one or more processors configured to execute the computer-readable instructions to:
receive an input, via a Graphical User Interface (GUI), the input identifying at least one operation to be performed in a Relational Database Management System (RDBMS) and at least one object subject to the operation, at a database layer;
identify the at least one object in the input;
automatically generate, in a single iteration, a Structured Query Language (SQL) script for the at least one operation using a grouping of the at least one object identified in the input, wherein the script is used to build a new software database based thereon; and
output the script on the GUI.

9. The device of claim 8, wherein the one or more processors are configured to generate the script by:
grouping the at least one object based on a referential order; and
generating a corresponding script for each object in the group.

10. The device of claim 9, wherein the one or more processors are further configured to add the corresponding script of each object in the group to generate the script.

11. The device of claim 8, wherein the one or more processors are further configured to:
determine whether the at least one object is missing from the RDBMS;
generate an error message indicative of the at least one object missing; and
include the error message in the script.

12. The device of claim 8, wherein the at least one operation includes a SQL operation to be performed on at least one database in the RDBMS.

13. The device of claim 8, wherein the operation includes migrating at least one database in the RDBMS between two different environments, each of the two different environments being one of a development environment, a test environment, and a deployment environment for the RDBMS.

14. One or more non-transitory computer-readable media comprising computer-readable instructions, which when executed by one or more processors of a device, cause the device to:
receive an input, via a Graphical User Interface (GUI), the input identifying at least one operation to be performed in a Relational Database Management System (RDBMS) and at least one object subject to the operation, at a database layer;
identify the at least one object in the input;
automatically generate, in a single iteration, a Structured Query Language (SQL) script for the at least one operation using a grouping of the at least one object identified in the input, wherein the script is used to build a new software database based thereon; and
output the script on the GUI.

15. The one or more non-transitory computer-readable media of claim 14, wherein the execution of the computer-readable instructions cause the device to generate the script by:
grouping the at least one object based on a referential order; and
generating a corresponding script for each object in the group.

16. The one or more non-transitory computer-readable media of claim 15, wherein the execution of the computer-readable instructions further cause the device to add the corresponding script of each object in the group to generate the script.

17. The one or more non-transitory computer-readable media of claim 14, wherein the execution of the computer-readable instructions further cause the device to:
determine whether the at least one object is missing from the RDBMS;
generate an error message indicative of the at least one object missing; and
include the error message in the script.

18. (canceled)

19. The one or more non-transitory computer-readable media of claim 14, wherein the at least one operation includes a SQL operation to be performed on at least one database in the RDBMS.

20. The one or more non-transitory computer-readable media of claim 14, wherein the operation includes migrating at least one database in the RDBMS between two different environments, each of the two different environments being one of a development environment, a test environment, and a deployment environment for the RDBMS.
